(19) United States
(12) Patent Application Publication
(10) Pub. No.: US 2004/0213658 A1
(43) Pub. Date: Oct. 28, 2004

(54) Tow hitch arrangement

(75) Inventors: Robert Ian Hedley, Milbrodale (AU); David Peter White, Cessnock (AU)

Correspondence Address: Clifford C. Dougherty, III, McAfee & Taft, Two Leadership Square, Tenth Floor, 211 North Robinson, Oklahoma City, OK, 73102, US

(73) Assignee: Justoy Pty Ltd., New South Wales (AU)

(21) Appl. No.: 10/756,984

(22) Filed: Jan. 14, 2004

(30) Foreign Application Priority Data
Jan. 15, 2003 (AU) 2003900744

(51) Int. Cl. B66C 1/00

(52) U.S. Cl. 414/563

(57) ABSTRACT

A tow hitch assembly for attachment to a towing vehicle. The tow hitch assembly includes a tow hitch arm, attachment means, positioning means and lifting means.

The present invention relates to tow trucks and trailers, particularly those used in heavy industries such as mining, and more particularly to low-loading trailers, known as lowboys.

Lowboy trailers are typically used to transport heavy equipment such as drilling rigs, excavators and the like around mines and quarries. They are generally adapted to allow the machinery which is to be transported to be loaded onto the trailer as easily as possible, usually by manoeuvring under its own power onto a trailer lowered onto the ground at one end.

Once the machinery or vehicle is loaded onto the trailer, it is necessary to attach a tow truck to the trailer so that the trailer may be towed to the desired location. This involves raising the end of the trailer which was previously lowered to permit loading of the transported equipment. Since the weight of equipment typically transported by such trailers exceeds 300 tons, and the weight of the tow truck is typically in the region of 125-150 tons, it is not uncommon for the tow truck to struggle to lift the trailer off the ground into the towing position, and even for the wheels of the tow truck to temporarily leave the ground.

These problems can have consequences in that they put excess pressure on the tow truck and lifting/towing equipment. This, in turn, can have an adverse effect on the reliability of the equipment and, over time, may result in accelerated dilapidation of the equipment.

An example of such a prior art system is U.S. Pat. No. 5,435,586. This document discloses a tow hitch and gooseneck attachment for hauling vehicles. In use, the tow hitch attachment is coupled with a trailer, and then using the gooseneck, the trailer is lifted into the towing position. However, due to the weight of the trailer, including its cargo, the towing vehicle can be inclined to over-balance during the lifting process.

Alternatively, attempts have been made to load trailers from a rear end so as to avoid the problems associated with front end loading as discussed above. However, this practice requires jacking up the trailer, removing its rear wheels, lowering the rear end of the trailer to the ground for loading, and jacking up the rear end once more in order to replace the rear wheels of the trailer for transportation. The task is further complicated where the rear wheels of the trailer incorporate a braking system which must also be disconnected when the wheels are removed, and then reconnected when they are replaced. Consequently, this is a rather tedious and time consuming exercise.

### SUMMARY OF THE INVENTION

In a first broad form, the present invention provides a tow hitch assembly for attachment to a towing vehicle, including:

a tow hitch arm having first and second ends;

first attachment means for pivotally and rotatably attaching the first end of the tow hitch arm to the towing vehicle;

second attachment means for coupling the second end of the tow hitch arm to a load to be towed;

positioning means disposed between said first and second ends of the tow hitch arm for manoeuvring the tow hitch arm into a coupling position; and

lifting means disposed towards the second end of the tow hitch arm for lifting the load to be towed into a towing position.

Preferably, the first attachment means includes a ball and socket joint.

Preferably, the second attachment means includes a hook for lifting the load to be towed.

Preferably, the second attachment means includes a locking mechanism to securely fasten the second attachment means to the load to be towed.

Preferably, the second attachment means includes a pair of slots for receiving a pair of locking bars to securely fasten the second attachment means to the load to be towed.

Preferably, the lifting means includes a hydraulic ram for engaging with the ground beneath the load to be towed and for lifting the load off the ground.

Preferably, the hydraulic ram extends from within the tow hitch arm, and when withdrawn is substantially hidden from view.

Preferably, the tow hitch arm rests upon a supporting member of the positioning means, and movement of the supporting member by the positioning means produces a corresponding movement of the tow hitch arm.

Preferably, the positioning means includes a plurality of piston arrangements for moving the supporting member.

Preferably, the positioning means includes first, second and third piston arrangements arranged such that said first and third piston arrangements are connected between opposite ends of the supporting member and a base member and, the second piston is connected between the base member and a cylinder of the third piston arrangement.

Preferably, the assembly further includes a towing member for attachment to the second end of the tow hitch arm, said towing member being arranged for coupling to a vehicle such that said vehicle may be towed.

Preferably, the tow hitch assembly further includes a trailer arranged for coupling to said second attachment means.

Preferably the trailer includes a recess for receiving said second attachment means, said recess including an anchor for engagement with said second attachment means.

In a second broad form, the present invention provides a loading trailer for attachment to a towing vehicle including:

a towing end for coupling to a towing vehicle;

a loading end for receiving a load;

a plurality of wheels being movably mounted adjacent to the loading end, said plurality of wheels being movable between a loading position wherein the wheels are arranged to provide vehicular access to the trailer, and a towing position wherein the wheels are arranged to allow transport of the trailer during towing.

Preferably, the wheels are arranged to provide vehicular access to the trailer by arranging the wheels outwardly of the loading end.

Preferably, the trailer includes:

a pair of arms having first ends movably mounted to the trailer, elbows pivotably mounted to the trailer, and second ends pivotably mounted to the said plurality of wheels,

wherein the arms are pivoted relative to the trailer so as to forcibly lever the loading end into contact with the ground and to upwardly lever the wheels above the ground, and the wheels are outwardly rotated relative to the arms whereby the wheels are arranged outwardly of the loading end.

Preferably, the wheels are pivotally mounted to the arms by coupling portions.

Preferably, the coupling portions include movable hooks which are adapted to support the weight of the trailer when the trailer is arranged in the towing position.

Preferably, the plurality of wheels includes a first and a second set of wheels. More preferably, the first and second sets of wheels each include four wheels.

Preferably, the arms pivot relative to the trailer around a first axis and the coupling portions pivot relative to the arms around second axes which are substantially perpendicular to the first axis.

Preferably, the arms are forcibly pivoted relative to the trailer by a first set of piston arrangements.

Preferably, the wheels are forcibly rotated relative to the trailer by a second set of piston arrangements.

Preferably, the arms are moved synchronously and symmetrically.

Preferably, the coupling portions are moved synchronously and symmetrically.

### BRIEF DESCRIPTION OF THE DRAWINGS

For a better understanding of the present invention and to understand how the same may be brought into effect, the invention will now be described by way of example only, with reference to the appended drawings in which:

FIG. 1 shows a partial perspective view of the coupling between a tow truck and low loading trailer according to an embodiment of the invention;

FIG. 2 shows a perspective view of a tow truck hauling a trailer according to an embodiment of the invention and demonstrating the small turning circle possible;

FIG. 3 shows a detailed view of the positioning arrangement forming part of the coupling arrangement shown in FIG. 1;

FIG. 4 shows a detailed view of the positioning arrangement of FIG. 3 operating to achieve a sideways motion of the tow hitch assembly;

FIG. 5 shows a detailed perspective view of the coupling element positioned at the end of the tow hitch assembly distal to the anchor point;

FIGS. 6-13 show detailed perspective views of the individual stages in the coupling of the tow hitch assembly to the trailer;

FIG. 14 shows an attachment which may be fitted to the tow hitch assembly for towing a broken down vehicle;

FIG. 15 shows the attachment of FIG. 14 when attached to the tow hitch assembly; and

FIG. 16 shows a tow truck towing a broken down vehicle using the towing attachment of FIG. 14.

FIG. 17 shows a top view of one embodiment of the loading trailer arranged in a towing position and not carrying a load.

FIG. 18 shows a side view of the embodiment of the loading trailer in FIG. 17.

FIG. 19 shows a top view of the embodiment of the loading trailer in FIG. 17 whereby the loading end of the platform is raised to allow release of the support hooks from beneath the platform.

FIG. 20 shows a side view of the embodiment of the loading trailer whereby the loading end of the platform is raised to allow release of the support hooks from beneath the platform.

FIG. 21 shows a side view of the embodiment of the loading trailer in FIG. 17 wherein the support hooks have been rotated away from beneath the loading end of the platform.

FIG. 22 shows a top view of the embodiment of the loading trailer in FIG. 17 whereby the first pistons are partially retracted into the first cylinders to enable the loading end of the platform to be lowered to the ground whilst the wheels are still in contact with the ground.

FIG. 23 shows a side view of an embodiment of the loading trailer in FIG. 17 whereby the first pistons are partially retracted into the first cylinders to enable the loading end of the platform to be lowered to the ground whilst the wheels are still in contact with the ground.

FIG. 24 shows a top view of the embodiment of the trailer in FIG. 17 whereby the first pistons are fully retracted into their respective first cylinders whereby the loading end is resting in contact with the ground and the wheels are raised above the ground.

FIG. 25 shows a side view of the embodiment of the trailer in FIG. 17 whereby the first pistons are fully retracted into their respective first cylinders whereby the loading end is resting in contact with the ground and the wheels are raised above the ground.

FIG. 26 shows a top view of the embodiment of the trailer in FIG. 17 whereby the wheels are raised above the ground and outwardly rotated from the loading end of the trailer in readiness for vehicular loading.

FIG. 27 shows a side view of the embodiment of the trailer in FIG. 17 whereby the wheels are raised above the ground and outwardly rotated from the loading end of the trailer in readiness for vehicular loading.

FIG. 28 shows a top view of the embodiment of the trailer in FIG. 17 whereby the wheels are raised above the ground and outwardly rotated from the loading end and the trailer is carrying a load.

FIG. 29 shows a side view of the embodiment of the trailer in FIG. 17 whereby the wheels are raised above the ground and outwardly rotated from the loading end and the trailer is carrying a load.

FIG. 30 shows a top view of the embodiment of the trailer in FIG. 17 whereby the wheels are raised above the ground and have been inwardly rotated toward the loading end and of the trailer which is loaded.

FIG. 31 shows a side view of the embodiment of the trailer in FIG. 17 whereby the wheels are raised above the ground and have been inwardly rotated toward the loading end and of the trailer which is loaded.

FIG. 32 shows a top view of the embodiment of the trailer in FIG. 17 whereby the wheels are inwardly rotated toward the loading end, the wheels have been lowered into contact with the ground, and the trailer is loaded.

FIG. 33 shows a side view of the embodiment of the trailer in FIG. 17 whereby the wheels are inwardly rotated toward the loading end, the wheels have been lowered into contact with the ground, and the trailer is loaded.

FIG. 34 shows a top view of the embodiment of the trailer in FIG. 17 whereby the wheels are inwardly rotated toward the loading end, the wheels have been lowered into contact with the ground, and the loading end of the platform has been raised such that the support hooks can be rotated into position beneath the platform.

FIG. 35 shows a side view of the embodiment of the trailer in FIG. 17 whereby the wheels are inwardly rotated toward the loading end, the wheels have been lowered into contact with the ground, and the loading end of the platform has been raised such that the support hooks can be rotated into position beneath the platform.

FIG. 36 shows a top view of the embodiment of the trailer in FIG. 17 in position for towing whereby the wheels are inwardly rotated toward the loading end, and are in contact with the ground, and the support hooks are releasably engaged with the recess on the lower surface of the loading end of the loading platform.

### DESCRIPTION OF THE INVENTION

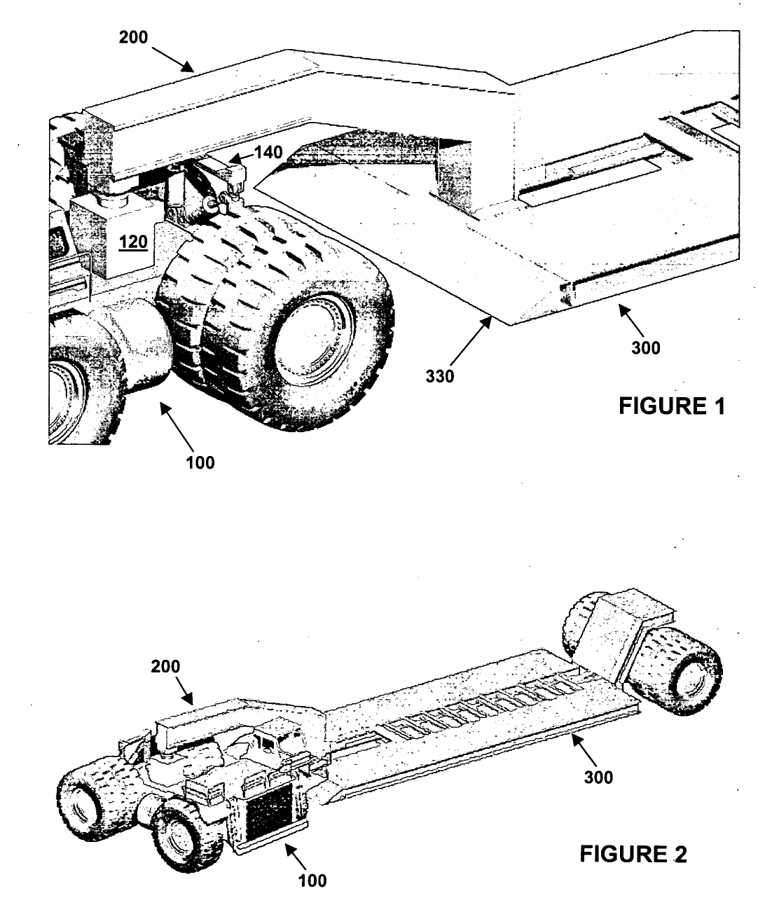

FIG. 1 shows a perspective view of the rear portion of a tow truck vehicle 100 to which is attached a tow hitch arm 200 according to an embodiment of the present invention. Also shown is a low loading trailer 300 arranged for towing by the tow truck 100. At the front end of the trailer 300 is a ramp 330 by which the trailer cargo may be loaded onto the trailer.

The tow truck 100 may be any one of a number of different types of tow truck known in the prior art. The tow truck 100 is adapted according to embodiments of the invention by the addition of anchor point 120 and positioning arrangement 140.

The anchor point 120 permits the secure attachment of the tow hitch arm 200 to the tow truck 100. The tow hitch arm 200 is rotatably and pivotally attached to the anchor point 120 by means of a ball and socket joint. Such a connection allows the tow hitch arm 200 to move from side to side, up and down, and to tilt such that the plane of the tow hitch arm 200 is non-parallel with the ground on which the truck 100 is located.

The second modification made to the tow truck 100 to enable attachment of the trailer 300 is the addition of positioning arrangement 140. The tow hitch arm 200 sits on the positioning arrangement 140, and is thus able to assume one of a range of different positions depending on the relative positions of the individual piston arrangements making up the positioning arrangement 140. The tow hitch arm 200 is prevented from sliding off the positioning arrangement by the provision of an end stop at either end of a supporting plate 152.

FIG. 2 shows a perspective view of the tow truck 100 coupled to the trailer 300 via tow hitch arm 200. This figure illustrates how use of a tow hitch arm according to embodiments of the invention allows the tow truck to achieve a smaller turning circle than would be possible with certain prior art arrangements.

Since the anchor point 120 of the tow hitch arm 200 is some way toward the front of the tow truck, and the tow truck 100 can position itself so that it is at right angles to the trailer 300, as shown, the turning circle is minimised. Note that the tow hitch arm 200 is dimensioned so that if the vehicle adopts the position shown in FIG. 2, the tow hitch arm passes over the rear wheel of the tow truck.

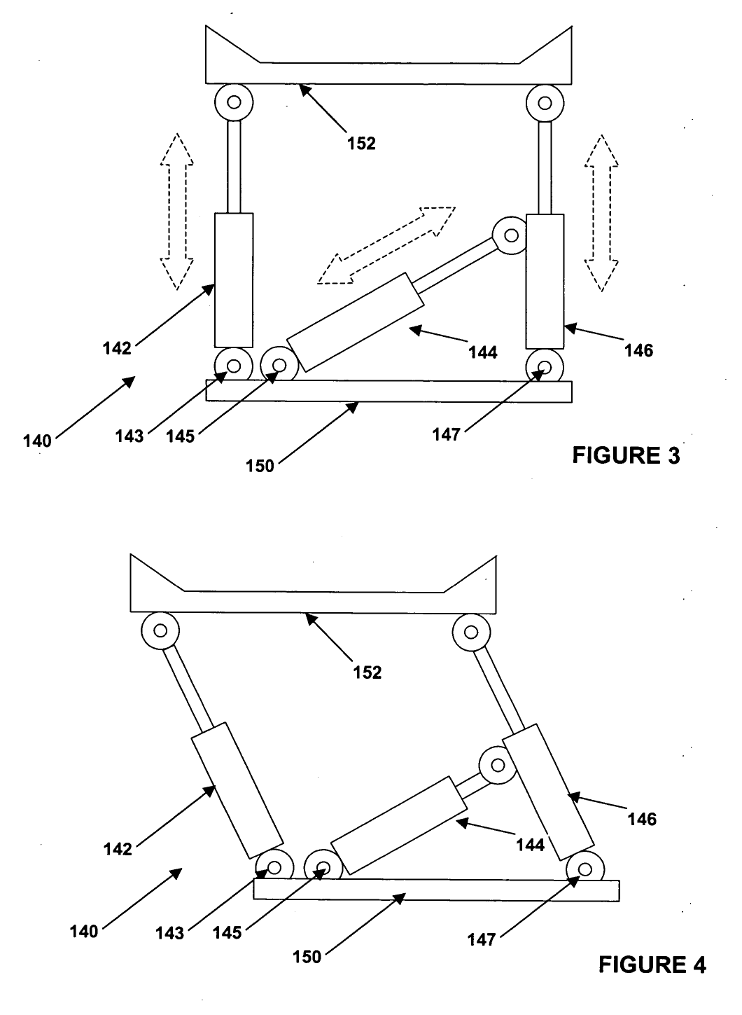

FIG. 3 shows a detailed view of the positioning arrangement 140. The positioning arrangement includes three piston arrangements 142, 144, 146 interconnected between a base member 150 and the supporting plate 152. Each piston arrangement 142, 144, 146 includes a cylinder or bore in which is situated a close-fitting piston, as is known in the art. The piston arrangements are operated via one or more hydraulic pump systems as is known in the art.

Base member 150 is a metal (e.g. steel) plate and is securely attached to the tow truck 100 by means of welding, nuts and bolts or any other suitably strong fixing means.

Pivotally attached to the base member 150 at pivots 143, 145 and 147 respectively are the cylinders of the three piston arrangements 142, 144 and 146. Piston arrangements 142 and 146 are pivotally connected at their piston ends to the supporting plate 152. The piston of piston arrangement 144 is pivotally connected to the cylinder of piston arrangement 146 at an end distal to the pivot point 147.

Each piston of the piston arrangements 142, 144, 146 is movable in the normal manner in a longitudinal direction as indicated by the dotted arrows shown in FIG. 3. Movement is obtained through use of a hydraulic power system as is known. As such, if it is desired to raise the tow hitch arm 200, which rests on supporting plate 152, then this can be achieved by activating piston arrangements 142 and 146 only. In this way, the supporting plate 152 is urged away from the base member 150, and the tow hitch arm 200 is raised further above the ground.

If it is desired to tilt the tow hitch arm because, for example, uneven ground between the two truck 100 and trailer 300 makes alignment between the two difficult, then piston arrangements 142 and 146 can be operated independently so that supporting plate 152 is not parallel with the base member 150. In this way, the tow hitch arm 200, which is anchored to the tow truck at ball and socket joint 120, tilts and may thus be made to couple more easily with the trailer 300.

Side to side motion of the supporting plate 152 may be accomplished by use of piston arrangement 144. By operating piston arrangement 144 with or without operating piston arrangements 142 and 146, the supporting plate 152 can be made to move side to side, thus causing a similar motion in the tow hitch arm, which may enable it to be coupled more easily with the trailer 300.

This type of motion is illustrated in FIG. 4, where piston arrangement 144 is operated such that its piston is withdrawn. This motion causes piston arrangement 146 to tilt from the vertical. Since piston arrangement 142 is connected to piston arrangement 146 via the supporting plate, it too tilts from the vertical in a similar manner to piston arrangement 146. By controlling piston arrangement 144, it is possible to move the supporting plate some distance to the left and right of its neutral or central position.

By combining operation of piston arrangement 144 with either or both of piston arrangements 142 and 146, the supporting plate 152, and thus the tow hitch arm 200, can be made to tilt, move up, down or sideways as is required to position the two hitch am for coupling to the trailer 300.

The tow hitch arm 200 is terminated at the end for coupling with the trailer 300, by a coupling element 210 being essentially rectangular in cross-section. The coupling element 210 is arranged to cooperate with a recess provided in the trailer 300.

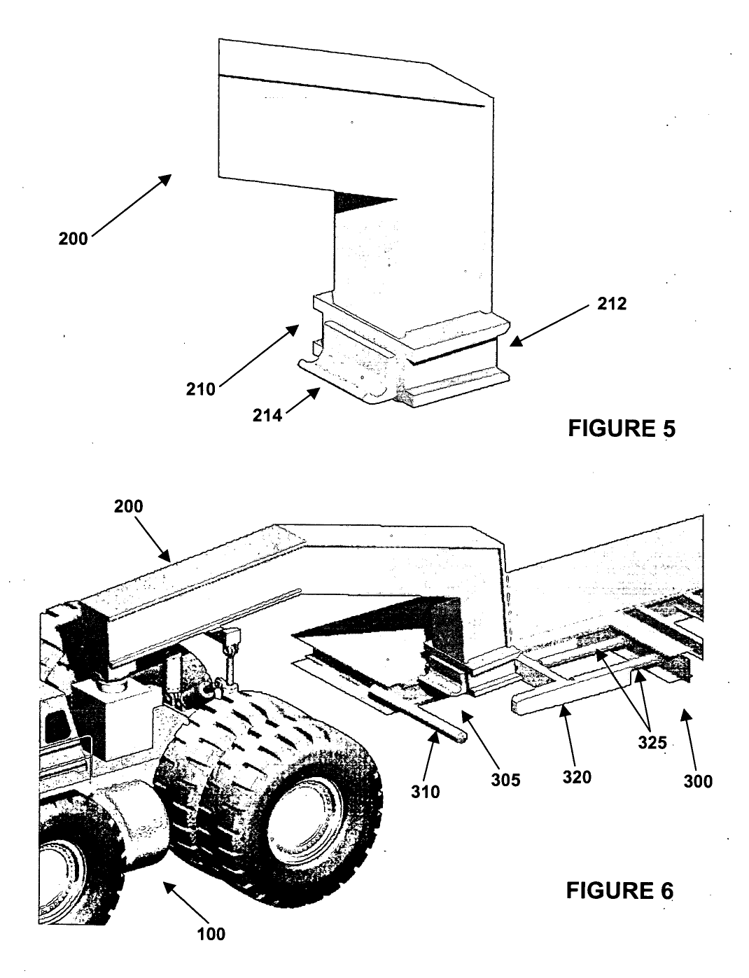

FIG. 5 shows a detailed view of the coupling element 210. Its lower portion includes a pair of protruding ridges which combine to form a slot 212 positioned generally parallel with the lower surface of the coupling element 210. Such a slot 212 is formed on two opposite faces of the coupling element 210. They are used to securely position the coupling element in a recess in the trailer 300 as will be described shortly.

Also shown in FIG. 5 on a third surface of the coupling element 210 is hook 214. The hook 214 is formed as a curved longitudinal element defining a shallow recess for receiving an anchor pole of the trailer 300. When the trailer is lifted, hook 214 bears the bulk of the weight of the trailer 300.

FIG. 6 shows a view of the truck 100, tow hitch arm 200 and a partially cutaway view of trailer 300 showing the interconnections which make coupling possible between the tow hitch arm 200 and trailer 300.

In the view of FIG. 6, the front end of the trailer 300, i.e. the end to which coupling takes place, is resting on the ground after a load (not shown) has been loaded on to the trailer 300.

The next stage is to couple the tow hitch arm 200 to the trailer 300 so that the trailer may be raised into a towing position. To do this, the operator of the tow hitch arm 200, manipulates the positioning arrangement 140 via an operator control system (not shown). In this way, he can manoeuvre the tow hitch arm 200 in the manner already described to ensure that the coupling element 210 is located in the recess 305 of the trailer 300.

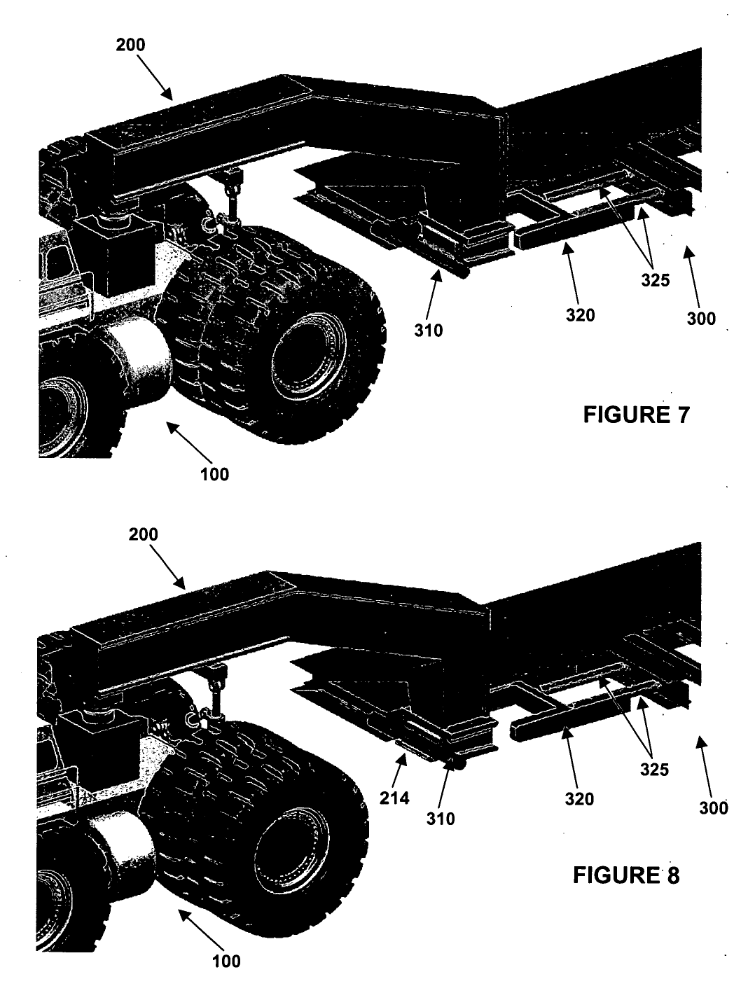

FIG. 7 shows the coupling element 210 successfully located in recess 305. The next step is to move the tow truck 100 forward a small distance so that the hook 214 can engage with the anchor bar 310 positioned at the front of the recess 305.

The result of this movement by the tow truck 100 is shown in FIG. 8.

The next step is to lift the trailer into the towing position. In prior art trailer systems, this is the point at which there is a danger that the tow truck 100 may over-balance or otherwise over-stress itself.

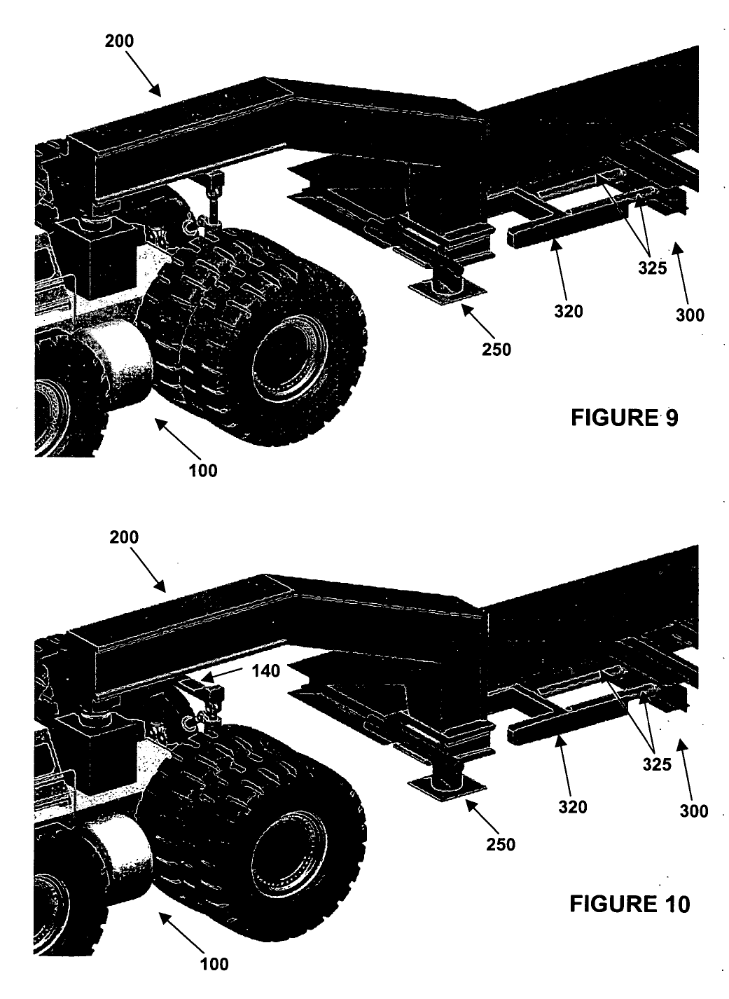

To provide a means for lifting the trailer 300 into the towing position without over-balancing the truck 100, the tow hitch arm 200 is provided with a lift ram 250 as shown in FIG. 9. The lift ram 250 is a hydraulic piston arrangement located within the lower portion of the tow hitch arm 200, and arranged to extend through the trailer 300 and contact the ground underneath when extended.

The lift ram 250 is configured to be able to provide the lifting power needed to raise the trailer plus its load off the ground and into the towing position. A suitable hydraulic system is able to use a 3,500 psi hydraulic system, and together with a hydraulic intensifier, is able to produce a hydraulic lifting ram operating as 10,000 psi. Use of a hydraulic intensifier enables a ram of smaller bore to be used. A suitable ram has a bore of approximately 15 cm. The lift ram 250 is provided with a flat lower surface to provide a stable base for contact with the ground.

Once the lift ram 250 has acted to raise the trailer 300 up to the height required for towing, the positioning arrangement 140 is withdrawn and all the weight of the trailer 300 plus load is borne by the lift ram 250. This is shown in FIG. 10.

The next step in the lifting operation is to secure the coupling element 210 in place in the recess 305 of the trailer 300. This ensures a firm connection between the tow truck 100 and the trailer 300.

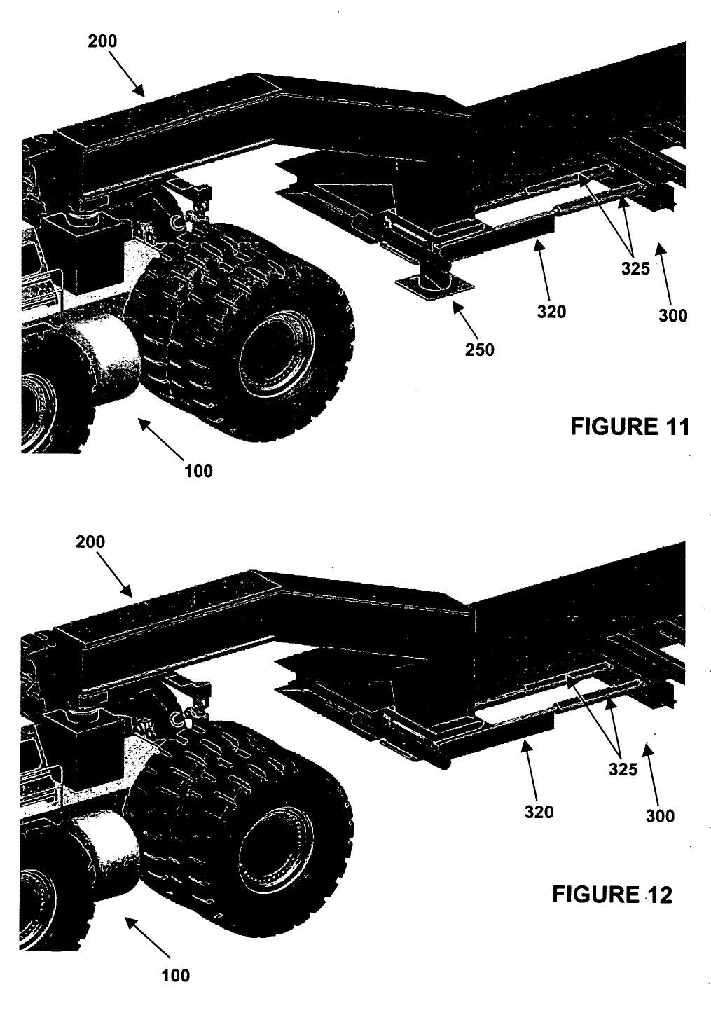

FIG. 11 shows how the slots 212 on the sides of the coupling element 210 are used to accommodate a pair of locking bars 320 which are located in the recess 305. The locking bars 320 are mounted on the ends of a pair of pistons housed in a pair of cylinders 325 secured to the trailer 300. The locking bars run on rails to guide them into slots 212 when the pistons 320 are activated. In this way, the coupling element is securely locked in position with its hook 214 engaging with the anchor bar 310 at the front of the trailer 300.

Optionally, once the locking bars 320 are in position, they may be held in position using a simple safety pin so that the hydraulic system used to position them may be deactivated.

The final stage in the procedure, before the trailer 300 may be driven off, is to retract the lift ram 250, so that the front of the trailer is clear of the ground. This is illustrated in FIG. 12 which shows the trailer at the required height, with the coupling element 210 locked into position and the lift ram retracted.

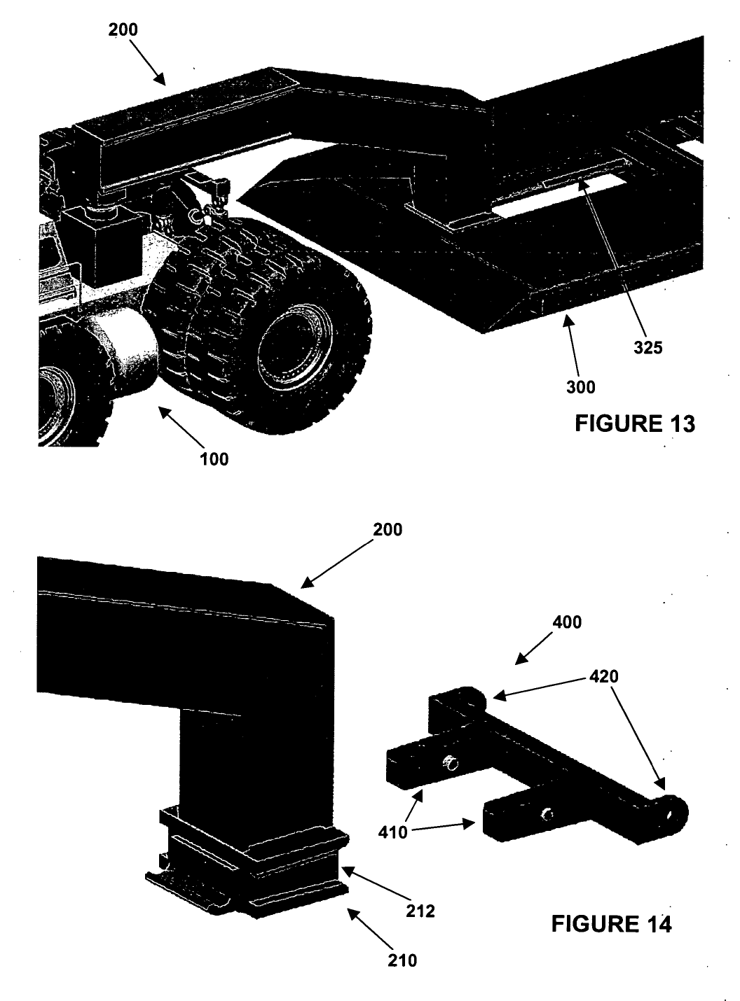

FIG. 13 shows a perspective view of the truck 100 coupled to the trailer 300 via the tow hitch 200 with the cutaway section replaced. The cylinder 325 associated with one of the locking bars 320 can be seen in the recess 305.

An additional feature of the present invention allows its use in the recovery of broken-down or otherwise inoperative tow trucks. FIG. 14 shows how towing attachment 400 may be attached to the coupling element 210 of the tow hitch assembly 210. Specifically, towing attachment 400 has a pair of elongate arms 410 for entry into the pair of slots 212 on the coupling element. Midway along the arms 410 are fixing devices such as bolts which allow the towing attachment 400 to be securely held in place.

Once securely attached to the tow hitch arm 200, the towing attachment 400 may be attached to another vehicle by coupling flanges 420, which protrude from towing attachment 400, to similar parts on the vehicle to be towed. The configuration of the towing attachment may be such that it conforms to a standard arrangement for towing attachment, or a specific custom towing arrangement may be required.

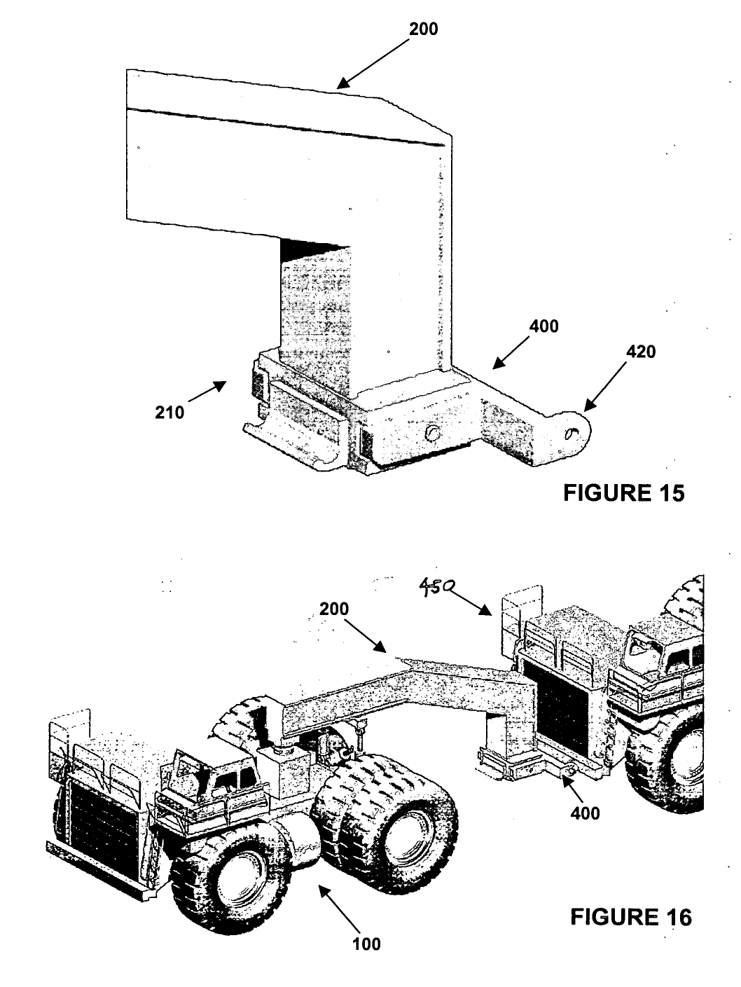

FIG. 15 shows the towing attachment 400 in situ attached to the coupling element 210. FIG. 16 shows the towing attachment in use towing a broken down vehicle 450.

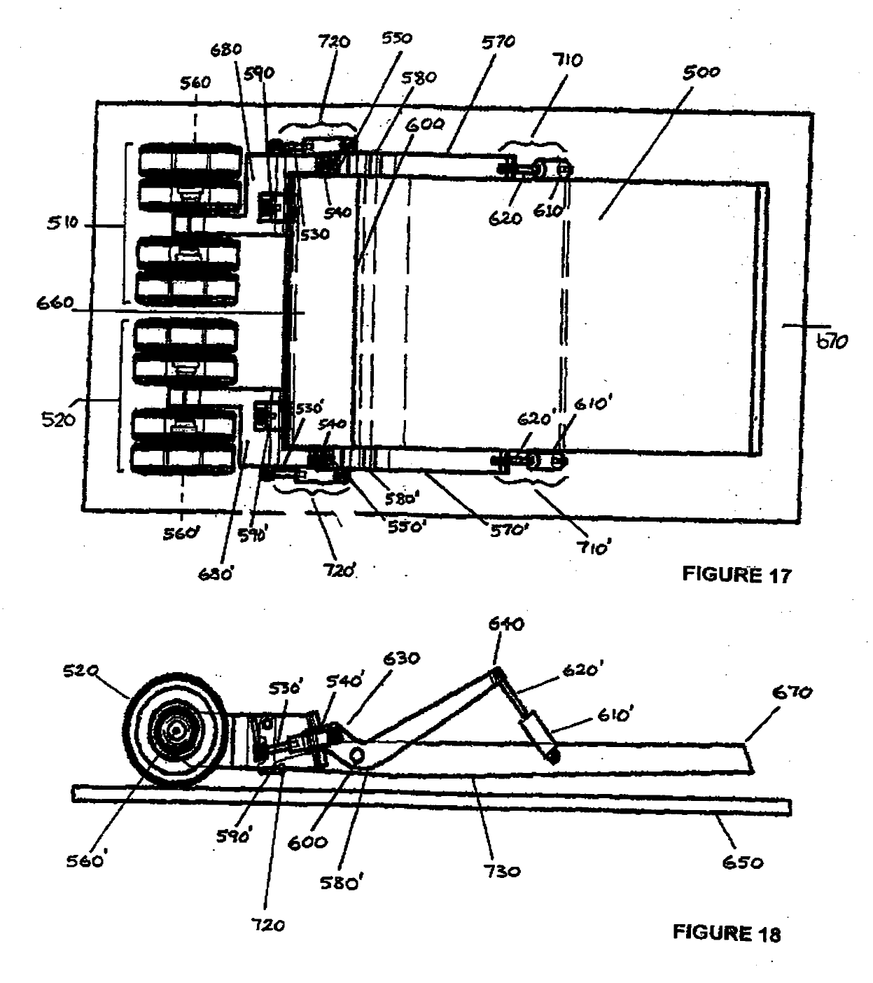

FIG. 17 depicts a second embodiment of the present invention including a loading platform 500 having a towing end 670 and a loading end 660, a first and second set of wheels 510,520 which are rotatably mounted to the loading end 660 by first and second coupling portions 680,690 respectively, twin pivot arms 570,570′, a pivot axel 600 which links the elbows 580,580′ of the pivot arms 570,570′, primary piston arrangements 710,710′ for vertically positioning the first and second sets of wheels 510,520 and secondary piston arrangements 720,720′ for horizontally positioning the first and second sets of wheels 510,520. The loading platform 500 is a substantially flat surface having a loading end 660 that is adapted to provide a ramp for vehicular access when the loading end 660 rests in contact with the ground 650. In use, the towing end 670 is firmly suspended above the ground by a towing vehicle.

Primary piston arrangements 710,710′ are disposed on opposite sides of the platform 500 as shown in FIG. 17 and each includes a first piston 620,620′ and a first cylinder 610,610′. The primary piston arrangements 710,710′ are of substantially identical dimensions and the choice of dimensions will depend upon the specific user requirements. In use, the primary piston arrangements 710,710′ move synchronously and symmetrically.

The secondary piston arrangements 720,720′ are located on the coupling portions 680,680′ and each includes a second piston 530,530′ and a second cylinder 540,540′. The secondary piston arrangements 720,720′ are substantially identical and, in use, are moved synchronously and symmetrically.

As shown in FIG. 17, the first and second sets of wheels 510,520 each consist of four wheels. The first and second sets of wheels 510,520 are coupled to corresponding coupling portions 680,680′ respectively by wheel axels passing through a central axis 560,560′ of each set of wheels 510,520. Also, as shown in FIG. 17, two wheels are disposed on either side of each coupling portion 680,680′ such that the wheels are substantially evenly spread across the loading end 660 of the platform 500 during towing.

As shown in FIG. 17, symmetrical first and second pivot arms 570,570′ are attached to opposite sides of the platform 500 and are pivotable around a pivot axel 600 which consists of a metal cylindrical rod. FIGS. 17 and 18 shows that the pivot axel 600 passes through the sides of the platform 500 and links the pivot arms 570,570′ at elbows 580,580′.

As shown in FIG. 18, the first ends 630,630′ of the pivot arms 570,570′ are coupled to corresponding coupling portions 680,680′ respectively. The coupling portions 680,680′ are, in turn, attached to the first and second sets of wheels 510,520. The second ends 640,640′ of the pivot arms 570,570′ are pivotally coupled to corresponding first pistons 620,620′ of the primary piston arrangements 710,710′ wherein movement of the first pistons 620,620′ relative to the first cylinders 610,610′ causes the pivot arms 570,570′ to pivot around the pivot axel 600. This in turn forces the first and second sets of wheels 510,520 to be either raised or lowered.

The coupling portions 680,680′ are secured to the first ends 630,630′ of the pivot arms 570,570′ and are rotatable around first and second axes 550,550′ respectively.

The coupling portions 680,680′ include rotatable hooks 590,590′ for supporting the weight of the loading platform 500 and securing the platform to the coupling portions 580,580′ during transportation of a load. The hooks 590,590′ are releasably engageable with a recess 720 disposed on a lower surface 730 of the loading end 660 of the loading platform 500 such that when the hooks 590,590′ are engaged with the recess, the hooks 590,590′ support the weight of the platform 500 and its load during transport. FIG. 18 shows the hooks 590,590′ releasably engaged with the recess 720. In this position the weight and positioning of the loading platform 500 prevents the hooks 590,590′ from be rotated away from the loading platform 500.

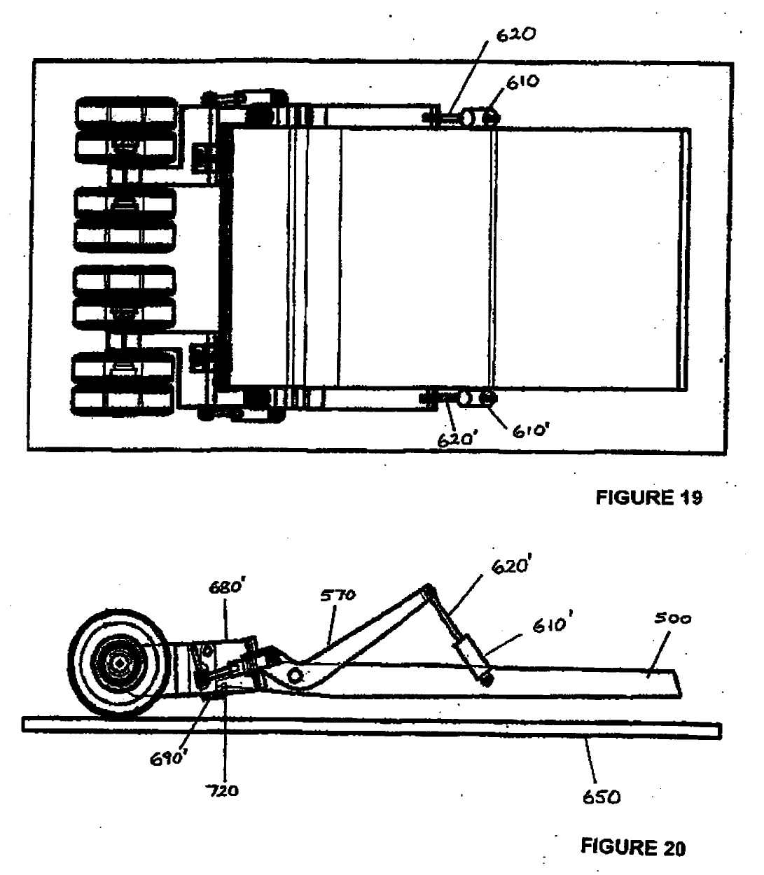

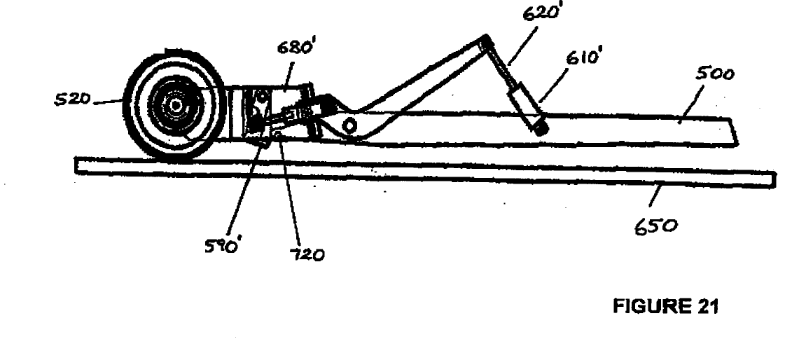

In order to arrange the platform 500 for loading, the first pistons 620,620′ are first extended out of the first cylinders 610,610′ causing the pivot arms 570,570′ and coupling portions 580,580′ to rotate in an anti-clockwise direction relative to the pivot axel 600 when viewed from the perspective of FIG. 18. As the first pistons 620,620′ are extended, the first and second sets of wheels 510,520 are forced downwardly against the surface of the ground 650, the loading end 660 of the platform 500 is raised. The loading end is raised to a point at which the support hooks 590,590′ can be freely rotated away from the platform 660 such that the platform 500 may then be lowered into contact with the ground 650 without any obstruction. FIGS. 19 and 20 show the first pistons 620,620′ extended outwardly of the first cylinders 610,610′. FIG. 20 also shows the loading end 660 in a raised position whereby the hooks 590,590′ are able to be rotated away from the loading end 660. FIG. 21 shows the hooks 590,590′ rotated away from the loading end 660 such that the loading end 660 can be lowered to the ground without the hooks 590,590′ obstructing its movement.

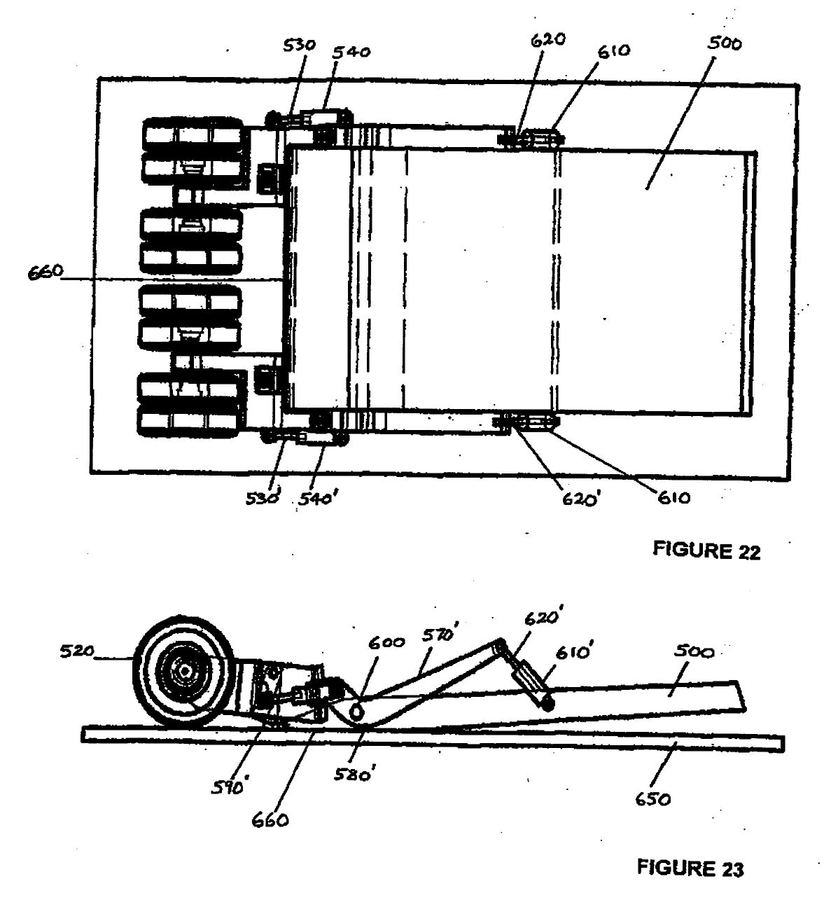

Next, the first pistons 620,620′ are retracted in to the first cylinders 610,610′ as shown in FIGS. 22 and 23. The retraction of the first pistons 620,620′ forces the pivot arms 570,570′ to pivot around the pivot axel 600 in a clockwise direction from the point of view shown in FIG. 20. As the pivot arms 570,570′ move in the clockwise direction from the point of view of FIG. 20, the loading end 660 of the loading platform 500 is simultaneously forced downwardly until the elbows 580,580′ rest against the surface of the ground 650. At this point, the loading end 660 of the platform 500 also abuts against the surface of the ground 650 thus providing a ramp for access on to the loading platform 500 for vehicular loading once the wheels have been moved out of the way.

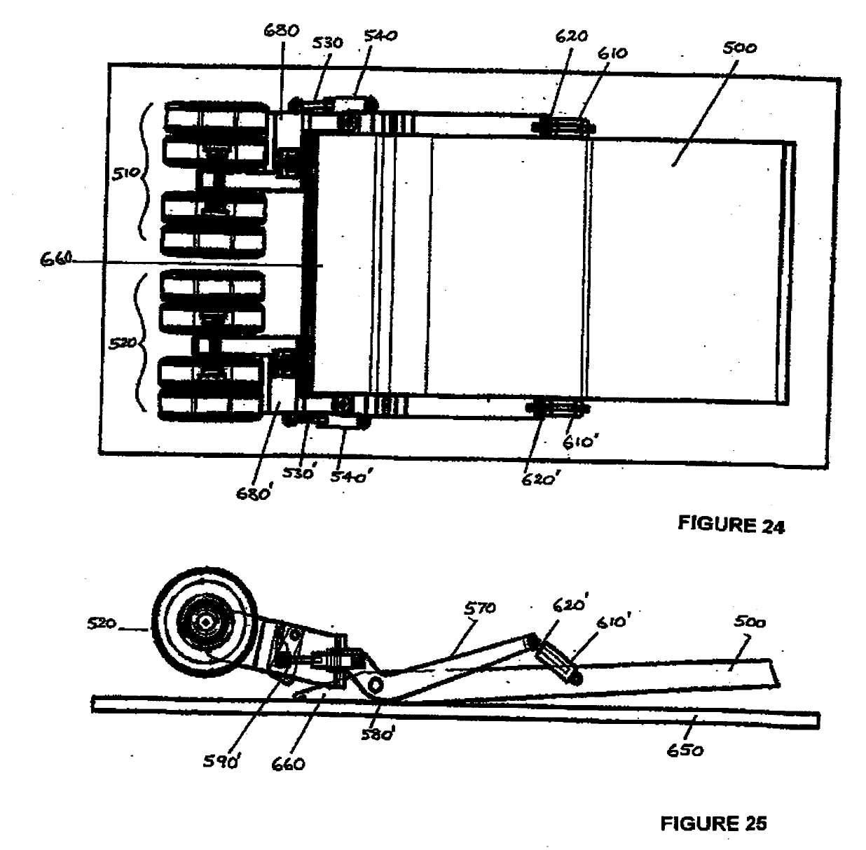

As the first pistons 620,620′ are further retracted into the first cylinders 610,610′, the pivot arms 570,570′ are rotated in the anti-clockwise direction relative to the pivot axel 600 from the point of view shown in FIG. 24, such that the coupling portions 580,580′ and their respective sets of wheels 510,520 are forcibly raised to an angle of approximately 20 degrees above the surface of the ground 650. The first pistons 620,620′ are fully retracted into the first cylinders 610,610′ at this point as shown in FIGS. 24 and 25. The first and second sets of wheels 510,520 are now positioned so as to be outwardly rotatable relative to the loading end 660 of the platform 500.

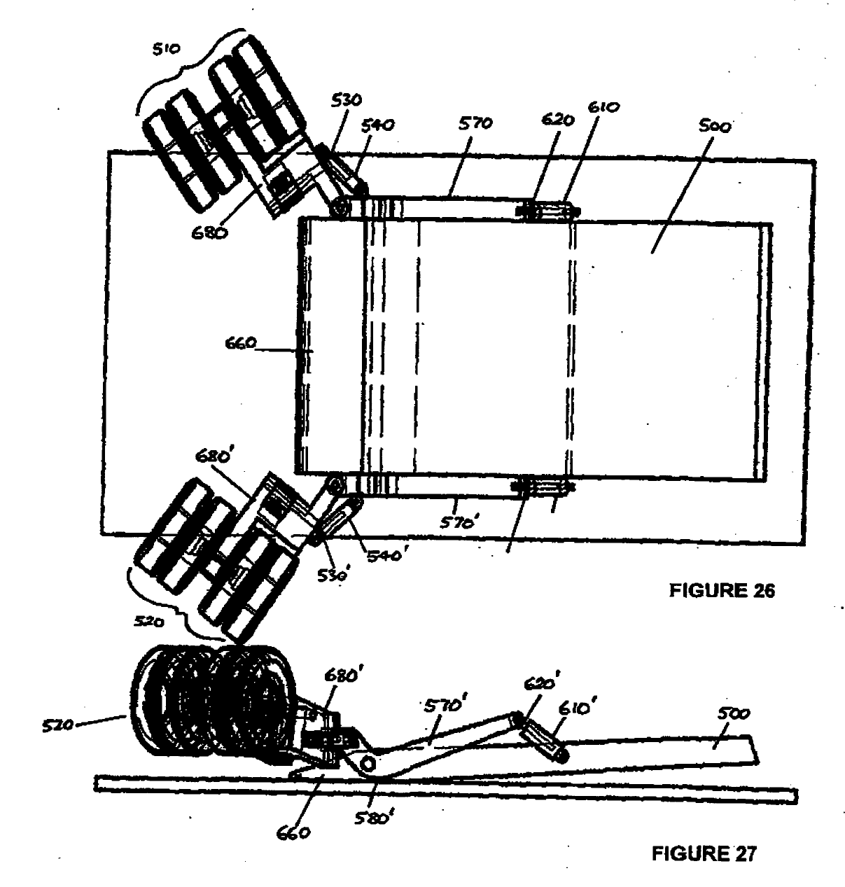

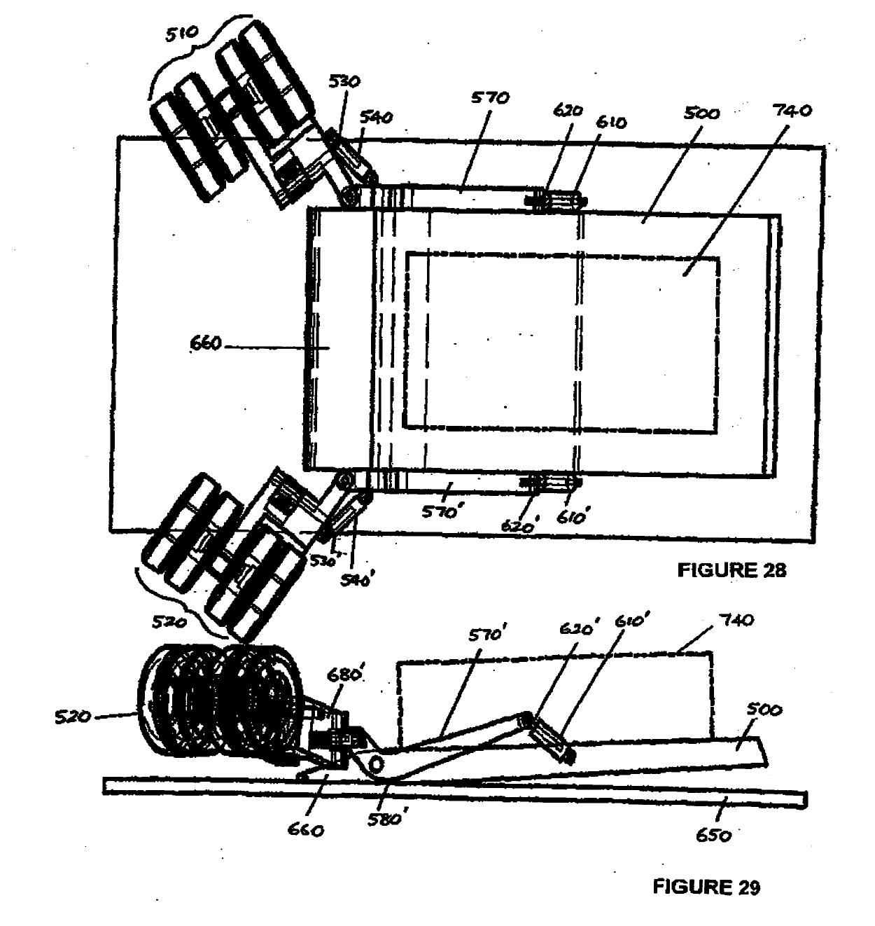

In order to outwardly rotate the first and second sets of wheels 510,520 from the loading end 660 of the platform 500, the second pistons 530,530′ are retracted in to the second cylinders 540,540′ wherein the first and second sets of wheels 510,520 are forcibly rotated laterally outward of the loading end 660 to an angle of approximately 45 degrees relative to the loading platform 500. FIGS. 26 and 27 show the wheels outwardly rotated from the loading end 660 which provides an unobstructed passage for a vehicle to be driven up the inclined loading platform 500. FIGS. 28 and 29 show the platform after being loaded with a load 740.

In the present embodiment, the first and second sets of wheels 510,520 are fitted with pneumatically-driven braking systems. Furthermore, the first and second sets of wheels 510,520 are positionable during loading of the loading platform 500 in such a way that the braking systems need not be decoupled at any stage. This is because there is no need to decouple the trailer from the towing vehicle.

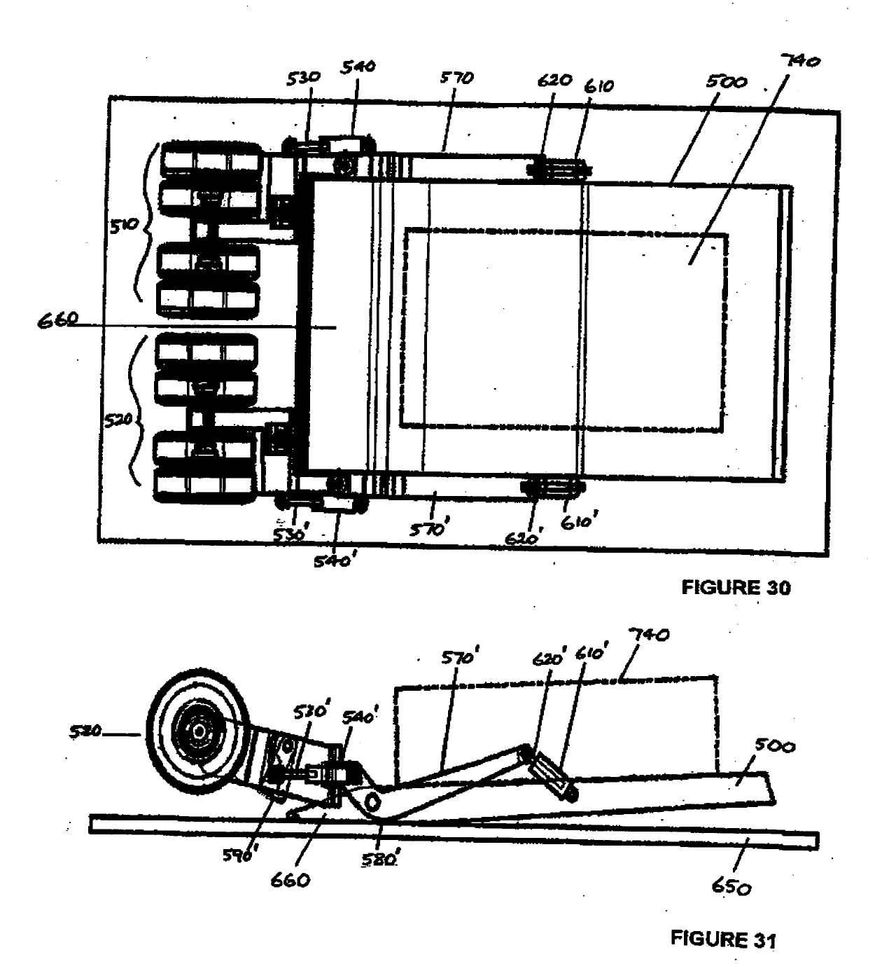

Once the loading platform 500 has been loaded, the first and second sets of wheels 510,520 are then re-positioned in preparation for transportation. To accomplish this, the second pistons 530,530′ are extended outwardly of the second cylinders 540,540′ thus forcing the first and second sets of wheels 510,520 to rotate laterally inward of the loading end 660 until the first and second sets of wheels 510,520 are in axially aligned as shown in FIG. 30. At this point, the loading end 660 of the platform 500 is still resting in contact with the ground 650 and the first and second sets of wheels 510,520 are still raised above the ground 650 as shown in the side view of FIG. 31.

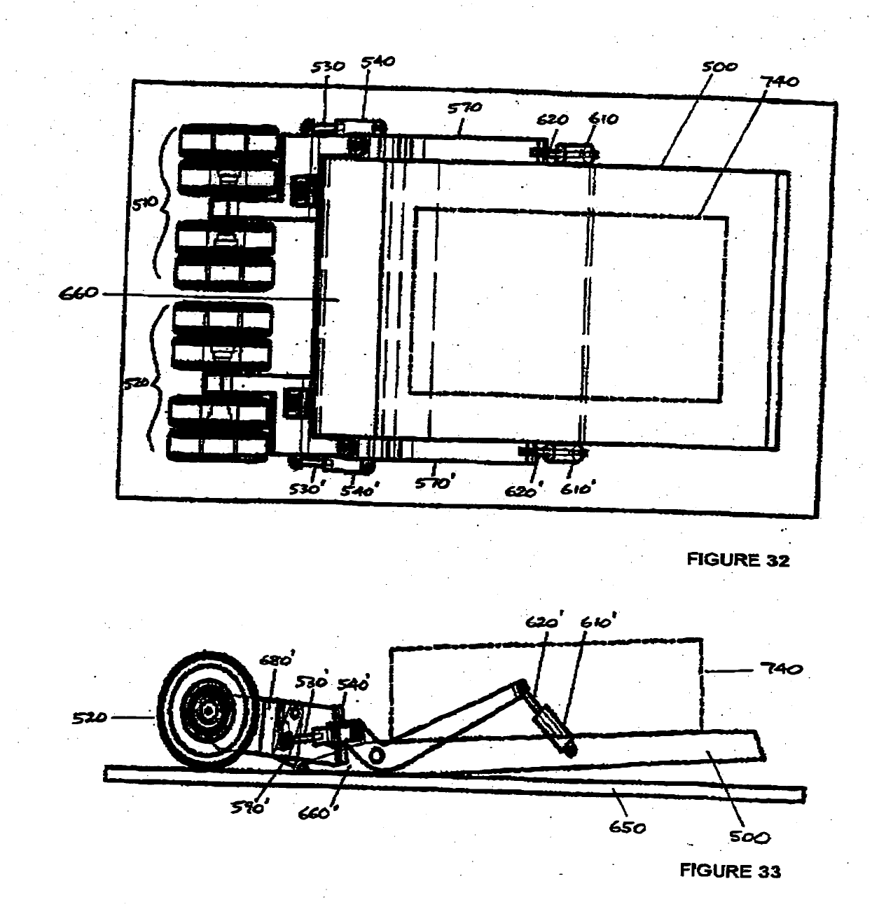

The first pistons 620,620′ are then extended outwardly of the first cylinders 610,610′ causing the pivot arms 570,570′ to pivot relative to the pivot axel 600 in an anti-clockwise direction from the point of view shown in FIG. 33, such that the first and second sets of wheels 510,520 are lowered into contact with the ground 650 as shown in FIGS. 32 and 33.

At this point the loading end 660 of the platform 500 is still in contact with the surface of the ground as shown in FIGS. 32 and 33. By further extending the first pistons 620,620′ outwardly of the first cylinders 620,620′, the first and second sets of wheels 510,520 are forced against the surface of the ground 650 whereby the weight of the trailer is shifted away from the pivot arm elbows 580,580′ and on to the first and second sets of wheels 510,520.

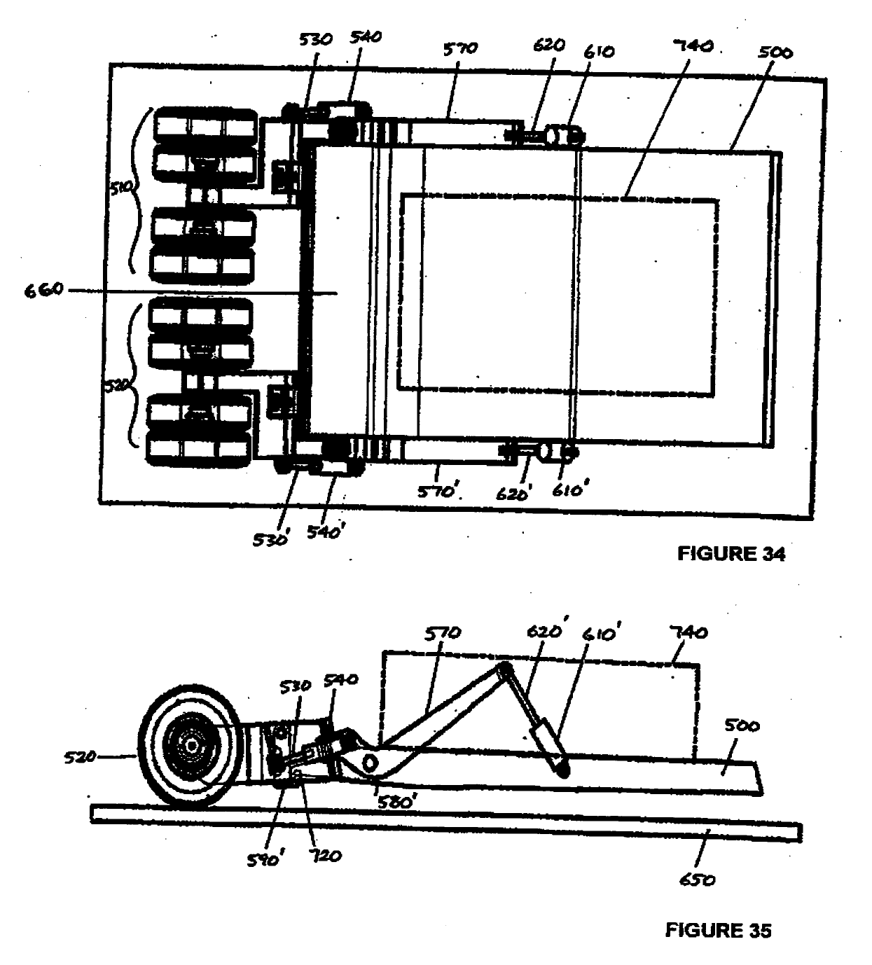

As the first and second pistons 620,620′ are further extended outwardly of the first and second cylinders 610,610′ respectively, the elbows 580,580′ are forcibly raised above the surface of the ground 650. The raised elbows 580,580′ force upwardly against the pivot axel which in turn forcibly raises the loading end 660 of the platform 500 from the inclined position and into a raised position whereby the hooks 590,590′ mounted to the coupling portions 580,580′ are rotated into position under the loading end 660 of the loading platform 500 as shown in FIGS. 34 and 35.

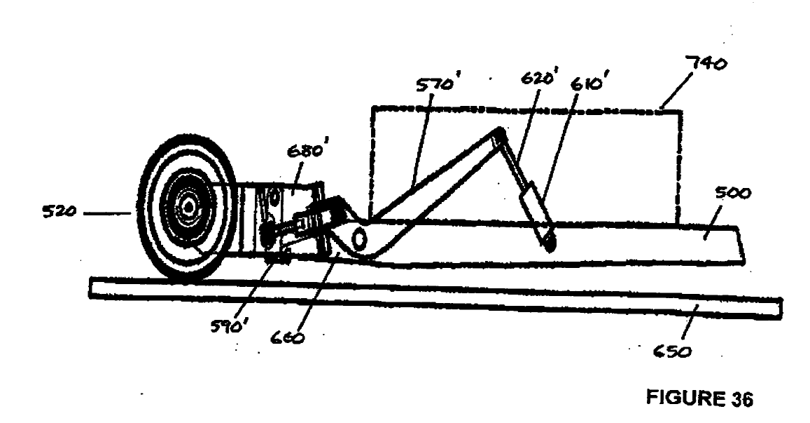

When the hooks are situated under the loading end 660, the first pistons 620,620′ are then retracted into the first cylinders 610,610′ until the weight of the platform 500 and its load rests securely upon hooks 590,590′. At this point, the hooks 590,590′ are securely engaged with the recess 720, and, the surface of the loading platform 500 is substantially parallel with the surface of the ground as shown in FIG. 36.

In the light of the foregoing description, it will be clear to the skilled man that various modifications may be mode within the scope of the invention.

The present invention includes and novel feature or combination of features disclosed herein either explicitly or any generalisation thereof irrespective of whether or not it relates to the claimed invention or mitigates any or all of the problems addressed.

1. A tow hitch assembly for attachment to a towing vehicle, including:
a tow hitch arm having first and second ends;
first attachment means for pivotally and rotatably attaching the first end of the tow hitch arm to the towing vehicle;
second attachment means for coupling the second end of the tow hitch arm to a load to be towed;
positioning means disposed between said first and second ends of the tow hitch arm for manoeuvring the tow hitch arm into a coupling position; and
lifting means disposed towards the second end of the tow hitch arm for lifting the load to be towed into a towing position.

2. A tow hitch assembly as claimed in claim 1 wherein the first attachment means includes a ball and socket joint.

3. A tow hitch assembly as claimed in claim 1 wherein the second attachment means includes a hook for lifting the load to be towed.

4. A tow hitch assembly as claimed in claim 1 wherein the second attachment means includes a locking mechanism to securely fasten the second attachment means to the load to be towed.

5. A tow hitch assembly as claimed in claim 4 wherein the second attachment means includes a pair of slots for receiving a pair of locking bars to securely fasten the second attachment means to the load to be towed.

6. A tow hitch assembly as claimed in claim 1 wherein the lifting means includes a hydraulic ram for engaging with the ground beneath the load to be towed and for lifting the load off the ground.

7. A tow hitch assembly as claimed in claim 6 wherein the hydraulic ram extends from within the tow hitch arm, and when withdrawn is substantially hidden from view.

8. A tow hitch assembly as claimed in claim 1 wherein the tow hitch arm rests upon a supporting member of the positioning means, and movement of the supporting member by the positioning means produces a corresponding movement of the tow hitch arm.

9. A tow hitch assembly as claimed in claim 8 wherein the positioning means includes a plurality of piston arrangements for moving the supporting member.

10. A tow hitch assembly as claimed in claim 9 wherein the positioning means includes first, second and third piston arrangements arranged such that said first and third piston arrangements are connected between opposite ends of the supporting member and a base member and, the second piston is connected between the base member and a cylinder of the third piston arrangement.

11. A tow hitch assembly as claimed in claim 1 wherein the assembly further includes a towing member for attachment to the second end of the tow hitch arm, said towing member being arranged for coupling to a vehicle such that said vehicle may be towed.

12. A tow hitch assembly as claimed in claim 1 further including a trailer arranged for coupling to said second attachment means.

13. A tow hitch assembly as claimed in claim 12 wherein said trailer includes a recess for receiving said second attachment means, said recess including an anchor for engagement with said second attachment means.

14. A loading trailer for attachment to a towing vehicle including:
a towing end for coupling to a towing vehicle;
a loading end for receiving a load;
a plurality of wheels being movably mounted adjacent to the loading end, said plurality of wheels being movable between a loading position wherein the wheels are arranged to provide vehicular access to the trailer, and a towing position wherein the wheels are arranged to allow transport of the trailer during towing.

15. A loading trailer as claimed in claim 14 wherein the wheels are arranged to provide vehicular access to the trailer by arranging the wheels outwardly of the loading end.

16. A loading trailer as claimed in claim 15 including:
a pair of arms having first ends movably mounted to the trailer, elbows pivotably mounted to the trailer, and second ends pivotably mounted to the said plurality of wheels,
wherein the arms are pivoted relative to the trailer so as to forcibly lever the loading end into contact with the ground and to upwardly lever the wheels above the ground, and the wheels are outwardly rotated relative to the arms whereby the wheels are arranged outwardly of the loading end.

17. A loading trailer as claimed in claim 16 wherein the wheels are pivotally mounted to the arms by coupling portions.

18. A loading trailer as claimed in claim 17 wherein the coupling portions include movable hooks which are adapted to support the weight of the trailer when the trailer is arranged in the towing position.

19. A loading trailer as claimed in claim 14 wherein the plurality of wheels includes a first and a second set of wheels.

20. A loading trailer as claimed in claim 19 wherein the first and second sets of wheels each include four wheels.

21. A loading trailer as claimed in claim 17 wherein the arms pivot relative to the trailer around a first axis and the coupling portions pivot relative to the arms around second axes which are substantially perpendicular to the first axis.

22. A loading trailer as claimed in claim 16 wherein the arms are forcibly pivoted relative to the trailer by a first set of piston arrangements.

23. A loading trailer as claimed in claim 22 wherein the wheels are forcibly rotated relative to the trailer by a second set of piston arrangements.

24. A loading trailer as claimed in claim 16 wherein the arms are moved synchronously and symmetrically.

25. A loading trailer as claimed in claim 17 wherein the coupling portions are moved synchronously and symmetrically.
